(19) United States
(12) Patent Application Publication
(10) Pub. No.: US 2026/0192428 A1
(43) Pub. Date: Jul. 9, 2026

(54) Tool holding device for a hammer drill or chisel hammer with idling stroke and recoil damping

(71) Applicant: Hilti Aktiengesellschaft, Schaan (LI)

(72) Inventors: Maximilian KNYRIM, Ehingen (DE); Olaf KOCH, Kaufering (DE); Aaron WIEDNER, Landsberg (DE)

(21) Appl. No.: 19/132,153

(22) PCT Filed: Nov. 14, 2023
(86) PCT No.: PCT/EP2023/081709

§ 371 Date: May 22, 2025

(30) Foreign Application Priority Data
Dec. 2, 2022 (EP) 22211126.2

(51) Int. Cl. B25D 17/08; B25D 17/24

(52) U.S. Cl. CPC B25D 17/08; B25D 17/24; B25D 2222/57

(57) ABSTRACT

A tool holding device for a hammer drill or chisel hammer, including a tubular tool holding body for a tool, at the end stop of which there is provided a striking ram of a striking mechanism arranged coaxially at the rear, wherein the tool holding body is axially elastically mounted on both sides via at least two elastomer elements, wherein, for one operating direction, at least one first elastomer element is arranged axially between the tool holding body and a distal stationary housing stop, whereas, for the other operating direction, at least one second elastomer element is arranged axially between the tool holding body and a guide tube of the striking mechanism in order to implement idling stroke and recoil damping, wherein the elastomer elements interact with associated holding means in each case in order to be fastened to the tool holding body in an axially prestressed manner.

The present invention relates to a tool holding device for a hammer drill or chisel hammer.

### BACKGROUND

The field of application of the invention extends primarily to hand-held hammer drills or chisel hammers, which are equipped with an electric motor-driven drive. Such electric hand tools generate a linearly alternating working movement via a mechanical striking mechanism, i.e., a reciprocating movement to be applied to the tool, which, in the case of a chisel hammer, is designed as a mortise chisel and, in the case of a hammer drill, as a percussion drill for working on preferably mineral materials-such as stone, concrete and the like. Due to the interaction with the workpiece and the hand-arm system of the operator as well as the internal mass and stiffness distribution, an electric hand tool that can drive a tool to strike normally has complex vibration behavior that must be suppressed as far as possible.

In the context of the electric hand tools of interest here, tool holders are primarily used to fix and guide the drilling or chiseling tools in these machines. In the case of hammer drills, the tool holder transmits torques to the tool, ensures the transmission of impact pulses from the striking mechanism to the workpiece by allowing limited axial movements, and prevents the tool from unintentionally falling out of the machine. In the context of the striking mechanism pulses, the tool holder device according to the invention is in particular subjected to so-called idling strokes and recoil strokes.

### SUMMARY OF THE INVENTION

Idling strokes arise if tools are accelerated by impact pulses of the striking mechanism, but this impact energy cannot be transmitted to the workpiece since the tool is not resting against the workpiece. Recoil strokes arise when the tool rests too strongly and/or against an overly hard workpiece so that the impact pulses of the striking mechanism substantially act back on the machine.

US 2020 0119 600 A1 discloses a tool holder device of the type in question which is equipped with means for damping idling and recoil strokes. The tool holding device substantially consists of a tubular tool holding body for the tool, which is struck at the rear by a striking ram, a so-called snap die, of a pneumatic striking mechanism. The tool is locked within the tool holding body by a locking mechanism. For idling stroke and recoil damping, the tool holding body is mounted axially elastically on both sides by two elastomer elements, wherein the first elastomer element is arranged here axially between the tool holding body and a distal stationary housing stop. The second elastomer element is arranged axially between the striking ram of the striking mechanism and a guide tube of the striking mechanism, which comes to rest against a stationary housing stop opposite the end face. In this case, both elastomer elements are designed as O-rings and are prestressed via the adjacent component structures such as shoulder flanks, guide rings or sleeves so that the axial play of the tool holder is reduced, and the damping effect of the elastomer elements can be optimally exploited. On the other hand, the axial prestress which the elastomer elements bring about between the tool holding body and the machine housing causes friction between the adjacent components since the tool holding body can be moved, in particular also rotated, relative to the machine housing when the damping elements are in the clamped state. With battery-operated electric hand tools, this component friction leads to losses in energy with regard to battery capacity, which manifests itself in a significant reduction of the machine operating time, and in extreme cases can also lead to thermal failures due to heat development at the friction points.

It is an object of the present invention to further improve a tool holding device of the type in question with idling stroke and recoil damping in such a way that the that the component friction caused by the damping means is effectively reduced by simple technical means.

The present invention provides a tool holding device for a hammer drill or chisel hammer, comprising a tubular tool holding body (1) for a tool, at the proximal end of which there is provided a striking ram (2) of a striking mechanism (3) arranged coaxially at the rear, the tool holding body (1) being axially elastically mounted on both sides via at least two elastomer elements (7, 8), for one operating direction at least one first elastomer element (7) being arranged axially between the tool holding body (1) and a distal stationary housing stop (9), whereas, for the other operating direction, at least one second elastomer element (8) being arranged axially between the tool holding body (1) and a guide tube (5) of the striking mechanism (3) in order to implement idling stroke and recoil damping.

The invention includes the technical teaching that, for the axially elastic mounting of the tool holding body on both sides, the elastomer elements used for this purpose interact with associated holding means in each case in order to be fastened to the tool holding body in an axially prestressed manner. As a result, the tool holder according to the invention is mounted in a floating manner and thereby with reduced friction.

In other words, in the solution according to the invention, elastomer elements are used for damping axial impacts which are prestressed within the tool holder device and thereby do not press against the transmission housing or attachments immovably arranged thereon. The component friction in the region of the tool holding device is thereby considerably reduced. At the same time, the damping effect of the elastomer elements against axial impacts is ensured in the sense of idling stroke and recoil damping. Due to the fact that the holding means fasten the elastomer elements in an axially prestressed manner to the tool holding body, a certain degree of movement play arises between the corresponding holding means and the component of the tool holding device adjacent to the housing, which play can be the size of a minimum gap width so that component friction can be completely eliminated thereby, and the relatively stiff spring characteristic of a prestressed elastomer element can nevertheless be exploited. This is because without prestress, the spring deflection of the elastomer element would initially be too soft before the damping effect manifests. With the prestressed fastening of the elastomer element directly on the tool holding body implemented according to the invention, initially soft spring deflection, which does not contribute to effective idling stroke and recoil damping, is thus avoided.

According to a preferred embodiment, the holding means according to the invention each have a stop ring or a stop sleeve for the associated elastomer element and each have a locking ring for positively fastening the stop ring or the stop sleeve to the tool holding body in a prestress-generating axial position. Therefore only two components which are easy to manufacture are sufficient to generate the prestress in an elastomer element. In this case, the locking ring can be designed as a snap ring made of spring steel, and the stop ring corresponding thereto or the stop sleeve can be manufactured as a stamped and bent part from a sheet metal material.

According to a first embodiment, the stop ring for the first elastomer element should have an L-shaped cross section, which surrounds the first elastomer element by means of both legs on the outer wall side of the tool holding body. Since this damping point associated with the first elastomer element is realized on the outer circumference of the tool holding body, a stop ring that encloses the first elastomer element to save installation space is ideal.

The first elastomer element preferably has a rectangular cross section to match the shape of the aforementioned stop ring. As a result, the entire space formed between the L-shaped stop ring and the housing shoulder corresponding thereto on the tool holding body can be maximally filled with elastomer material, which in turn allows for optimal dimensioning.

Analogous to this, it is proposed within the context of the preferred embodiment that the stop ring for the second elastomer element, which likewise preferably has an L-shaped cross section, is arranged on the tool holding body in such a way that the outside of the axial leg thereof comes to rest on the inner wall of the tool holding body. The mounting position of the second stop ring is therefore on the inside circumference of the tool holding body, and preferably opposite the tube shoulder thereof on the outside of which the first elastomer element comes to rest. To prestress the second elastomer element in this installation position, the associated stop ring can be pushed into the tubular tool holding body and fixed in the target position by the locking ring. On the side of the elastomer element opposite the stop ring, there is an additional stop ring between this and the tool holding body, which forms an end stop in the entry direction of the striking ram which is recoil-dampened by the second elastomer element.

An elastomer element with a circular cross section is preferably used for the second damping point described above. Since there is sufficient installation space at this damping point in the radial direction, a stout cross-sectional shape can be omitted.

Preferably, the idling stroke and recoil damping consists of precisely two annular elastomer elements which are arranged concentrically with the axis of rotation of the tubular tool holding body. In this case, the two elastomer elements are each fastened to the tool holding body with an axial prestressing path of 1 to 30% of the axial element length. This prestressing path is, on the one hand, sufficient to not overly restrict the spring properties of the elastomer elements by the prestress and, on the other hand, sufficient prestress is applied in the strained region to implement the optimum spring characteristic for the intended use, as described above.

The present invention also provides a hammer drill or chisel hammer for working a mineral material, in particular concrete or rock.

### BRIEF DESCRIPTION OF THE DRAWINGS

Further measures improving the invention are described in more detail below together with the description of a preferred embodiment in reflection of the prior art. In the drawings:

FIG. 1 shows a partial longitudinal section of a tool holding device for a hammer drill or chisel hammer with idling stroke and recoil damping according to the prior art, and

FIG. 2 shows a partial longitudinal section of a tool holding device for a hammer drill or chisel hammer with idling stroke and recoil damping according to the invention.

### DETAILED DESCRIPTION

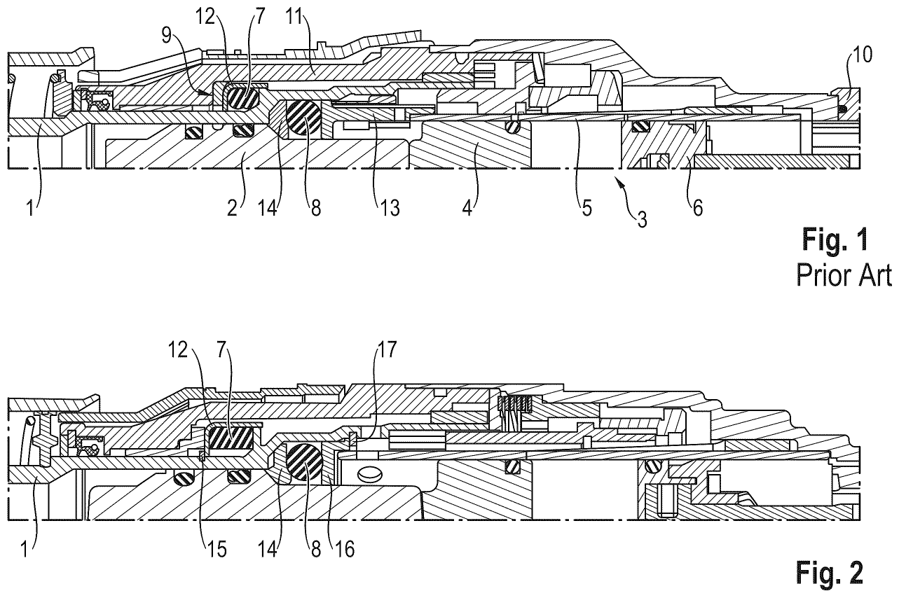

As can be seen from FIG. 1, a tool holding device which is known in the prior art and is therefore conventional for a hammer drill or chisel hammer-not shown in more detail here-usually consists of a tubular tool holding body 1, into which a grooved distal end region of a tool-also not shown here-can be inserted and then locked in the conventional manner.

In the locked state, a striking ram 2 of a striking mechanism 3 arranged coaxially at the rear with respect to the tool acts on the tool. The pneumatic striking mechanism 3 comprises an impact plunger 4 accommodated coaxially on the striking ram 2 and dynamically sealingly in a guide tube 5, which in turn is acted upon by a connecting rod drive 6 in a generally known manner.

The tool holding body 1 of the conventional tool holding device is axially elastically mounted on both sides via two annular elastomer elements 7 and 8. The first elastomer element 7 provided for one operating direction is arranged axially prestressed between the tool holding body 1 and a distal stationary housing stop 9. The housing stop 9 is a component of a housing extension 11 which is immovably attached to the machine housing 10 and extends it in the tool direction. The first elastomer element 7 is enclosed by a stop ring 12 which is arranged so as to be displaceable relative to the tool holding body 1 and is in this respect loose.

For the other operating direction of the damping, the second elastomer element 8 is used which acts axially between the tool holding body 1 and the guide tube 5 of the striking mechanism 3 as a component arrangement fixed to the housing on the location side. A bridging stop sleeve 13 is also provided here, which comes to rest on one side on the second elastomer element 8 and on the other side on the guide tube 5 of the striking mechanism 3. Opposite the second elastomer element 8 in the direction of the tool holding body 1 is a stop ring 14, which is also a bridging stop ring and serves as an end stop for the striking ram 2 in the entry direction.

According to FIG. 2, the two elastomer elements 7 and 8 for idling stroke and recoil damping are not arranged in the tool holding device so as to be prestressed via housing components. In the following description of the solution according to the invention, the same designations and reference signs apply to corresponding components as were used in the context of the above description of the prior art, and additional components are provided with further reference signs and designations.

Hence according to the invention, the two annular elastomer elements 7 and 8 are each provided according to the invention with associated holding means for axially prestressed attachment to the tool holding body 1 which, with regard to the first elastomer element, attaches the stop ring 12 to the tool holding body 1 with an additional locking ring 15 in such a way that the first elastomer element 7, which is rectangular in cross section here, is prestressed between the visible housing shoulder of the tool holding body 1 and the stop ring 12.

With regard to the second elastomer element 8, although the stop ring associated therewith also has an L-shaped cross section, this is oriented in a different mounting position relative to the adjacent components. This is because the short leg of the stop ring 16, which is L-shaped in cross section, comes to rest with its outer surface on the inside wall of the tool holding body 1, and is secured to the tool holding body 1 in the target position prestressing the elastomer element 8 by the associated locking ring 17. The second elastomer element 8 has a circular cross section.

As a result of the floating mounting of the tubular tool holding body within the tool holder device, which is realized by the two annular elastomer elements 7 and 8, in relation to stationary housing components, no friction-causing axial force acts on the housing components or their attachments due to the prestress of the elastomer elements 7 and 8 realized on the tool holding body, and therefore relative movements cannot cause friction.

The invention is not limited to the preferred exemplary embodiment described above. On the contrary, modifications thereof are also conceivable, which are encompassed by the scope of protection of the following claims. It is thus also possible, for example, to design the holding means exerting prestress on the tool holding body differently than L-shaped stop rings. Rather, other holding means such as flat rings, pressure sleeves and the like are also conceivable provided that they can be accommodated within the tool holding device. Instead of an annular elastomer element, a plurality of individual elastomer elements can also be provided which are arranged, for example, at a distance from one another around the tubular tool holding body.

### LIST OF REFERENCE SIGNS

1 Tool holding body
2 Striking ram
3 Striking mechanism
4 Impact plunger
5 Guide tube
6 Connecting rod drive
7 First elastomer element
8 Second elastomer element
9 Housing shoulder
10 Machine housing
11 Housing extension
12 First stop ring
13 Stop sleeve
14 First stop ring
15 First locking ring
16 Second stop ring
17 Second locking ring

What is claimed is:

1-10. (canceled)

11: A tool holding device for a hammer drill or chisel hammer, the tool holding device comprising:
a tubular tool holding body for a tool, the tubular tool holding body having a proximal end and an inner side and an outer side;
a striking mechanism having a guide tube and a striking ram at the at the proximal end and arranged coaxially to the tubular tool holding body;
a first and a second elastomer element elastically mounting the tool holding body on the inner and outer sides in order to implement idling stroke and recoil damping, for one operating direction the first elastomer element being arranged axially between the tool holding body and a distal stationary housing stop and for the other operating direction, the second elastomer element being arranged axially between the tool holding body and the guide tube;
holders interacting with the first and elastomer elements in each case in order to fasten the first and second elastomer elements to the tool holding body in an axially prestressed manner.

12: The tool holding device as recited in claim 11 wherein each of the holders has a stop ring and a locking ring for positively fastening the stop ring to the tool holding body in a pretension-generating axial position.

13: The tool holding device as recited in claim 12 wherein the stop ring for the first elastomer element has an L-shaped cross section with two legs and surrounding the first elastomer element via the two legs on the outer side.

14: The tool holding device as recited in claim 13 wherein the first elastomer element has a rectangular cross section.

15: The tool holding device as recited in claim 12 wherein the stop ring for the second elastomer element has an L-shaped cross section with an axial leg and is arranged on the tool holding body in such a way that an outside of the axial leg thereof comes to rest on the inner side.

16: The tool holding device as recited in claim 15 wherein the second elastomer element has a circular cross section.

17: The tool holding device as recited in claim 12 wherein the locking rings are designed as snap rings made of spring steel.

18: The tool holding device as recited in claim 11 wherein the first and second elastomer elements are annular and arranged concentrically with an axis of rotation of the tubular tool holding body and are the sole elastomer elements for implementing the idling stroke and recoil damping.

19: The tool holding device as recited in claim 11 wherein the first and second elastomer elements are fastened to the tool holding body with an axial prestressing path of 1 to 30% of the axial element length.

20: A hammer drill or chisel hammer for working a mineral material, the hammer drill or chisel hammer comprising the tool holding device as recited in claim 11.

21: A method for employing the hammer drill or chisel hammer as recited in claim 20 comprising working concrete or rock with the hammer drill or chisel hammer.
